(19) United States
(12) Patent Application Publication
(10) Pub. No.: US 2016/0375638 A1
(43) Pub. Date: Dec. 29, 2016

(54) Method of Additive Manufacturing for Producing Three-Dimensional Objects with One Or More Colors Through Light Exposure

(71) Applicants: Jacob Kabili, San Diego, CA (US); Allen McAfee, San Diego, CA (US); Braydon Moreno, San Diego, CA (US)

(72) Inventors: Jacob Kabili, San Diego, CA (US); Allen McAfee, San Diego, CA (US); Braydon Moreno, San Diego, CA (US)

(21) Appl. No.: 15/197,730

(22) Filed: Jun. 29, 2016

Related U.S. Application Data
(60) Provisional application No. 62/185,808, filed on Jun. 29, 2015.

(51) Int. Cl. B29C 67/00; B33Y 50/02; B33Y 40/00; B33Y 10/00

(52) U.S. Cl. CPC B29C 67/0085; B29C 67/0051; B29C 67/0088; B33Y 10/00; B33Y 50/02; B33Y 40/00

(57) ABSTRACT

A method of additive manufacturing for producing three-dimensional objects with one or more colors through light exposure utilizes a light source to dynamically change the color of a photosensitive fabrication material during an additive manufacturing process using an additive manufacturing unit to create a physical object from a digital 3D model. Various colors may be specified for various portions of the digital 3D model, resulting in corresponding colorings on the physical object.

The current application claims a priority to the U.S. Provisional Patent application Ser. No. 62/185,808 filed on Jun. 29, 2015.

### FIELD OF THE INVENTION

The present invention relates generally to manufacturing processes. More particularly, the present invention is a technique for full color additive manufacturing by exposing material to a light source during an additive manufacturing process.

### BACKGROUND OF THE INVENTION

Additive manufacturing, more commonly known as 3-D printing, is a process of creating a solid three-dimensional object from a digital file. From the bottom up, most 3-D printers build objects layer by layer in quick succession, producing shapes of almost any geometry, however, this may vary. Additive manufacturing is used to make a multitude of objects that may include but are not limited to tools, silverware, coat hangers, mobile phone cases, and even food.

As expected, not all 3-D printing processes are alike. There are several ways to print 3-D objects, with variances in layering techniques being common. Some of these techniques include but are not limited to binder jetting, material jetting, vat photopolymerization, powder bed fusion, sheet lamination, and more. Apart from layering, there are also different methods for 3-D printing parts in color, such as using different colored filaments and printing material, mixing and melting them together, and more. Such coloring processes often require expansive inventories comprising various printing material, which often increase manufacturing and other business related costs. Additionally, coloring techniques often produce unwanted defects or unsatisfactory parts, as changes in color along a printed model may have rough visible layer marks.

It is therefore an objective of the present invention to introduce a new technique for producing 3-D printed objects with one or more colors. The present invention utilizes photosensitive 3D printing material. When exposed to light at various wavelengths and/or exposure times, the photosensitive material will react by changing color. The material may change color due to the specific wavelength of light that it is exposed to, the duration of exposure, or both. As such, the present invention utilizes one or more light sources, such as a laser, in conjunction with a 3-D printer to add color into the infused printing material, before, during or after the layered printing process.

### BRIEF DESCRIPTION OF THE DRAWINGS

FIG. 1 is a stepwise flow diagram outlining the process of the present invention on a high level.

FIG. 2 is a stepwise flow diagram outlining the general process of the present invention.

FIG. 3 is a view of a basic 3D printer with a light source of the laser type producing wavelengths to the printing material as it exits the nozzle.

FIG. 4 is a stepwise flow diagram describing the steps of the general method of the present invention.

FIG. 5 is a stepwise flow diagram describing steps for initiating and executing various processes in the method of the present invention.

FIG. 6 is a stepwise flow diagram describing steps for activating the light source in the additive manufacturing process.

FIG. 7 is a stepwise flow diagram describing steps for iteratively repeating the general method of the present invention.

FIG. 8 is an illustration of the present invention being used in fused deposition molding.

FIG. 9 is an illustration of the present invention being used in stereolithography.

FIG. 10 is an illustration of the present invention being used in selective laser sintering.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

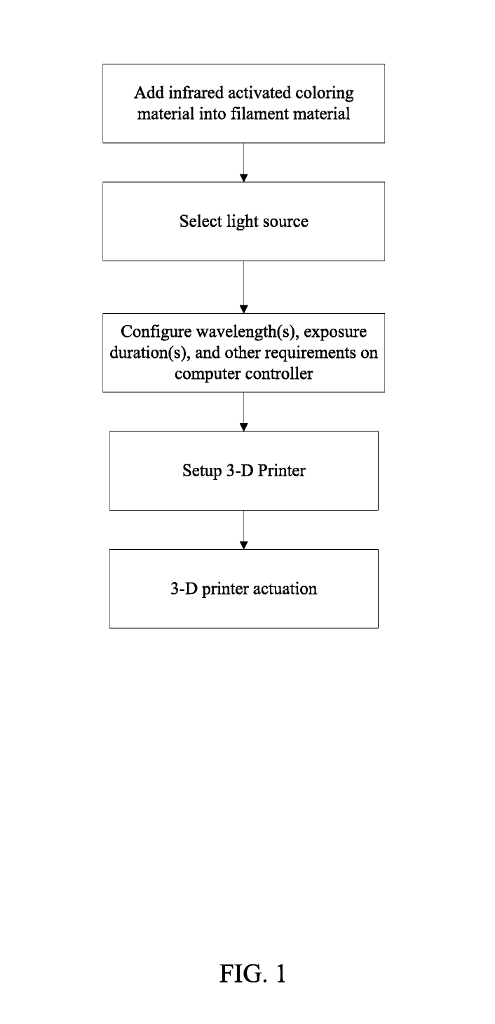

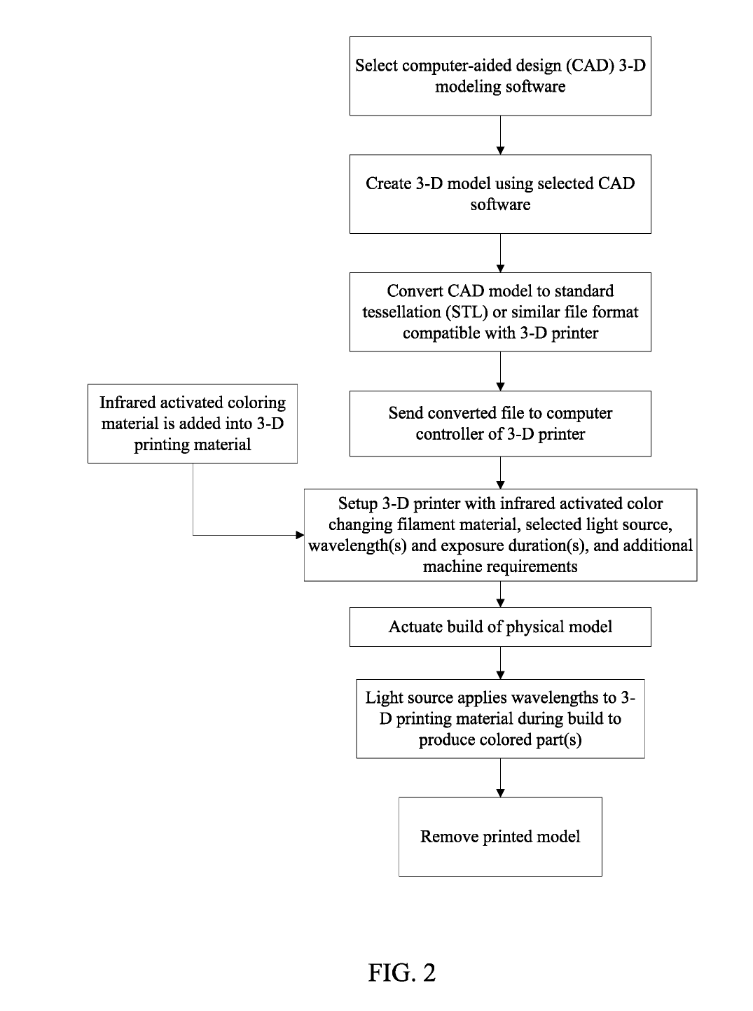

Referring to FIGS. 1-2, the present invention is a technique for producing 3-D printed objects with one or more colors. The present invention utilizes a photosensitive 3D printing material, a 3D printing unit, and a light source. When exposed to the light source, the photosensitive material will react by changing color. The photosensitive material may be changed to any desired color through exposure to the light source at given parameters necessary to achieve the desired color, such as, but not limited to, wavelength, exposure time, or both.

In the preferred embodiment, the present invention comprises a technique for full color additive manufacturing in conjunction with almost any 3D printing device. It is to be appreciated that the 3D printer may comprise components and arrangements known and understood by those skilled in the art, that may include, but are not limited to a stepping motor, mobile building platform, position adjustable extruder, height adjustable nozzle, heating element, sensors, a computer controller, and other components common to 3D printers or comprised in specific types of 3D printers, as relevant. It should be understood that the term “3D printer” and variations thereof will be used interchangeably with the term “additive manufacturing unit” herein. In general, a 3D printer works by using machine code to position a tool head in a defined 2D space and extrude, deposit, or cure material, subsequently moving to another position, repeating the process after moving the build plate in a small, defined increment, building and adhering to itself until it forms a 3D object. In order to color these materials, the present invention utilizes a wavelength of light, such as, but not limited to, infrared light, that is implemented at some point in the printing process to manipulate the properties of the material and expose a color of choice.

The computer controller is the primary control device to configure and actuate commands on the 3D printer. The computer controller may be integrated into the 3D printer or be a separate device that wirelessly or non-wirelessly interfaces with the 3D printer. The computer controller may be any electronic component which receives digital input signals and performs calculations and other operations with the input signals in order to produce digital output signals. The computer controller may be a microprocessor, a central processing unit (CPU) of a computing device such as, a desktop computer, a laptop computer, a tablet device, or a smartphone, or any other integrated circuit which is able to facilitate the function and operation of the present invention through computer-executable commands stored on a non-transitory computer-readable medium.

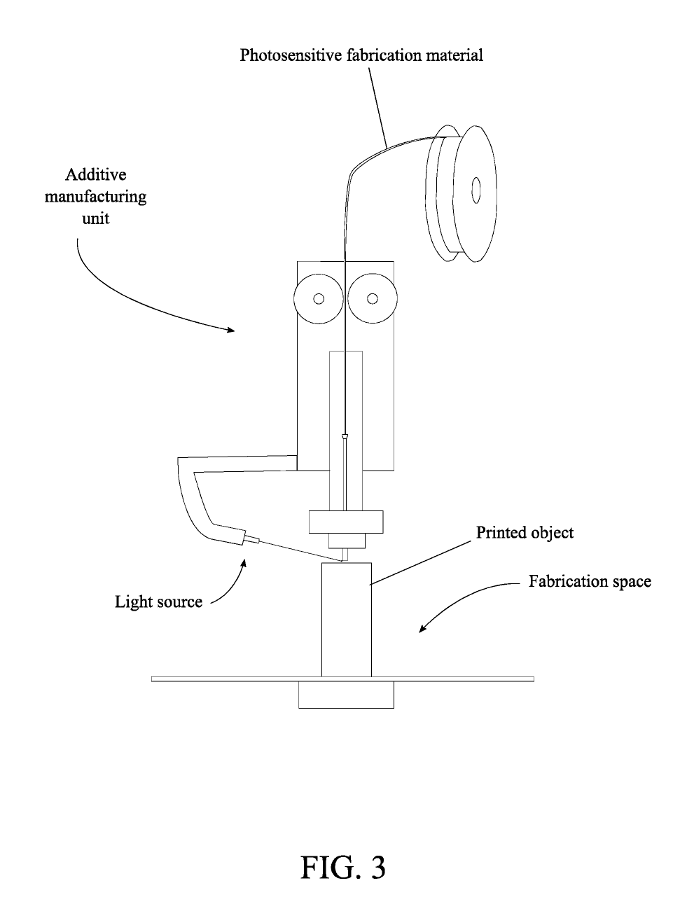

Referring to FIG. 3, the light source may be any type of light-emitting device which is capable of producing a spectrum of light necessary to change the color of the photosensitive fabrication material. In one embodiment, the light source is a laser. In one embodiment, the light source is an infrared light emitter. In one embodiment, the light source is an ultraviolet light emitter. The specific type of light source is inconsequential so long as the light source is capable of producing the type of light necessary to change the color of the photosensitive fabrication material, preferably to any color within a desired spectrum of color. The specific type of light source may vary in correlation with the specific type and material properties of the application-specific photosensitive fabrication material utilized. The light source should be capable of producing a range of wavelengths, frequencies, and intensities. The specific location of the light source in relation to the additive manufacturing unit may vary, as will be discussed hereinafter. In one embodiment, the light source may be affixed in a specific location and cannot move, and thus the platform upon which the physical object is being printed must move in order to expose the various portions of photosensitive fabrication material to the light source. In another embodiment, the light source may be connected to a motor mechanism which allows the light source to be moved around the fabrication space in two dimensions or in three dimensions in order to allow proper physical positioning of the light source to expose relevant portions of photosensitive fabrication material to the light source as needed. The light source may be controlled through machine code generated by a slicing engine, algorithm, or through manual activation.

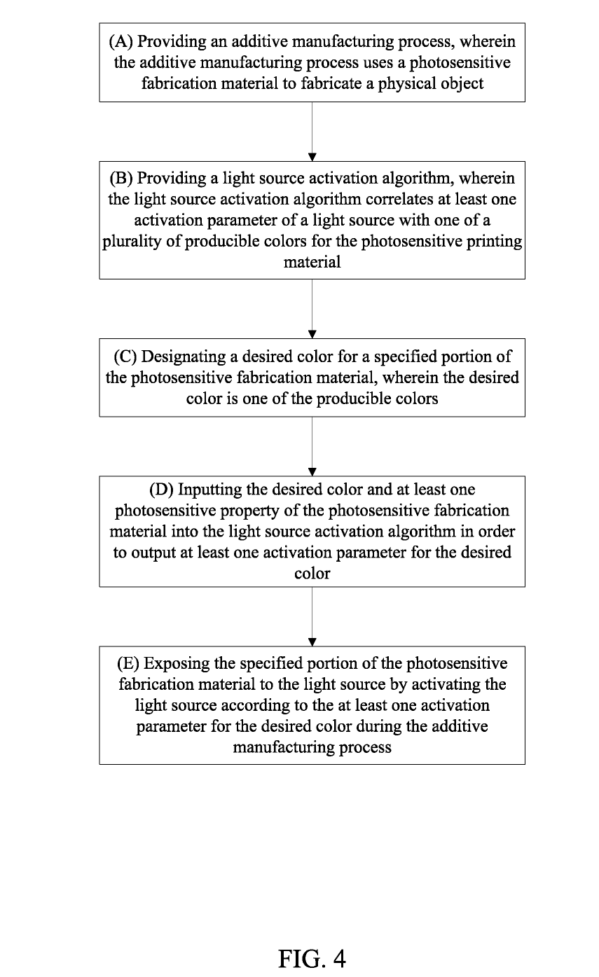

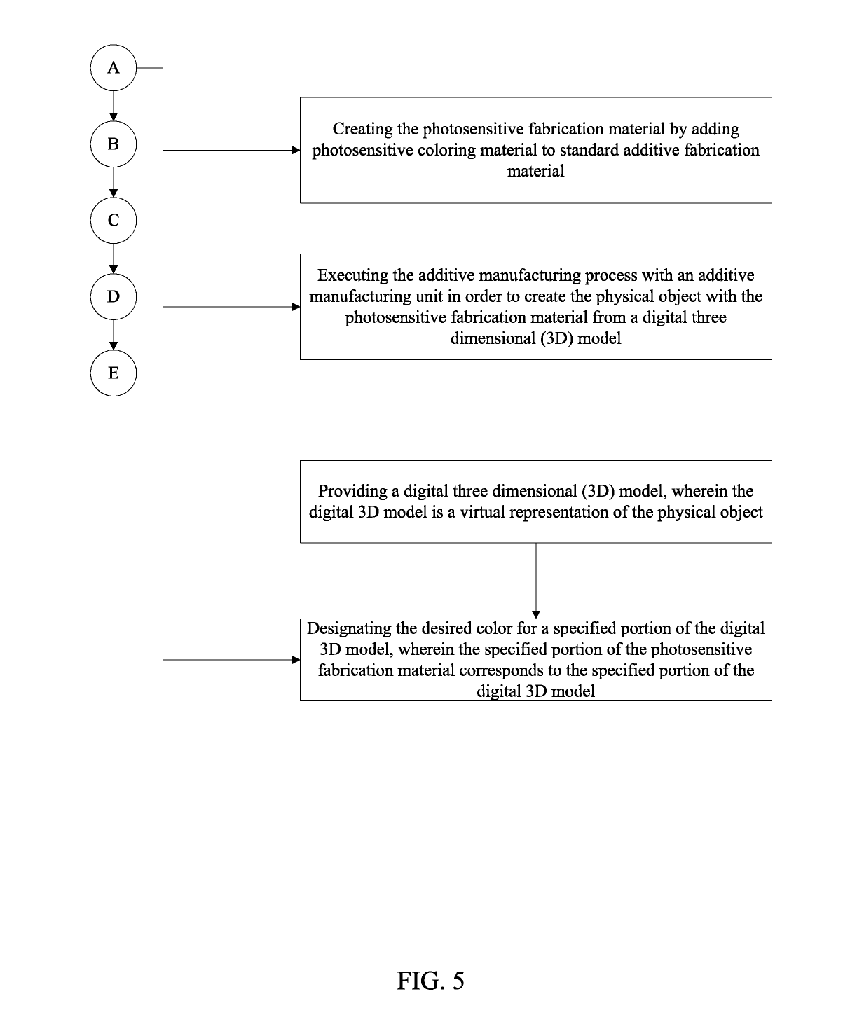

(A) Referring to FIGS. 4-5, In the general method of the present invention, an additive manufacturing process is provided. The additive manufacturing process uses a photosensitive fabrication material to fabricate a physical object. It should be understood that the additive manufacturing process is an abstract descriptor for the process of creating a physical object with an additive manufacturing unit. In the preferred embodiment of the present invention, the additive manufacturing process is executed with an additive manufacturing unit in order to create a physical object with the photosensitive fabrication material from a digital 3D model. The digital 3D model is a virtual representation of the physical object, and is created in any useful and relevant computer-aided design (CAD) software application. In most embodiments, the digital 3D model must be converted to a standard tessellation (STL) or similar file format compatible with the additive manufacturing unit.

Typical and currently known 3D printing processes use various types of source material to fabricate physical objects. In the additive manufacturing process of the present invention, a photosensitive fabrication material is utilized in the same manner. The specific nature and composition of the photosensitive fabrication material will vary significantly depending on the specific type of 3D printing process utilized with the present invention. In some embodiments, the photosensitive fabrication material is created by adding a photosensitive coloring material to standard additive fabrication material. In some embodiments, the photosensitive fabrication material will be specifically manufactured through any relevant manufacturing process to be photosensitive and usable with an additive manufacturing process. As previously mentioned, the specific process utilized to create the photosensitive fabrication material will vary depending on the specific type of additive manufacturing to be utilized with the present invention.

Colorants may be added to the printing material during the printing process, can be applied as a treatment to material before the printing process, can be manufactured into the printing material, or can be applied and activated to the model after the printing process. Properties of the colorants may require activation or application of the colorant before, during, or after the printing process to accommodate or exploit state changes due to exposure to thermal, UV, IR, or other print related variables. Different materials absorb IR or other types of light in various ways, allowing for color manipulation. Different rates of light absorption will impact the workflow for colorant activation. The wavelength of light, or time exposed to light, can influence or dictate the color produced.

(B) Furthermore, a light source activation algorithm is provided. The light source activation algorithm correlates at least one activation parameter of the light source with one of a plurality of producible colors for the photosensitive printing material. The light source activation algorithm is any portion of computer-executable commands which is capable of calculating activation parameters for the light source in order to produce a desired color for the photosensitive printing material. The light source activation algorithm will calculate necessary activation parameters for the light source in conjunction with known physical attributes of the photosensitive printing material in order to achieve the desired color. For example, if the desired color is red, the light source activation algorithm will calculate a wavelength, exposure duration, and/or intensity for the light source necessary to change the visible color of the photosensitive printing material to the color red.

In the general process of producing a colored 3D printed object, (C) a desired color is designated for a specified portion of the photosensitive fabrication material, the desired color being one of the colors producible through the light source activation algorithm. The specified portion of photosensitive fabrication material represents a continuous portion of the physical object to be 3D printed with the additive fabrication unit which has a uniform color. In most embodiments, the specified portion of photosensitive fabrication material will be a layer of material or portion of a layer of material in the print. More particularly, in the preferred embodiment, the desired color is designated for a specified portion of the digital 3D model, wherein the specified portion of the photosensitive fabrication material corresponds to the specified portion of the digital 3D model. It is contemplated that the designation of the desired color may be accomplished in numerous ways. In one embodiment, the desired color is designated in the CAD software application in which the digital 3D model was created. In one embodiment, the desired color may be automatically designated through a given coloring algorithm. In one embodiment, the desired color may be designated through a user interface connected to the additive manufacturing unit.

(D) The desired color and at least one photosensitive property of the photosensitive fabrication material is inputted into the light source activation algorithm in order to output at least one activation parameter for the desired color. The activation parameter(s) for the desired color are the parameters by which the light source must be activated in order to achieve the desired color for the specified portion of photosensitive fabrication material. (E) Subsequently, the specified portion of the photosensitive fabrication material is exposed to the light source by activating the light source according to the at least one activation parameter for the desired color during the additive manufacturing process.

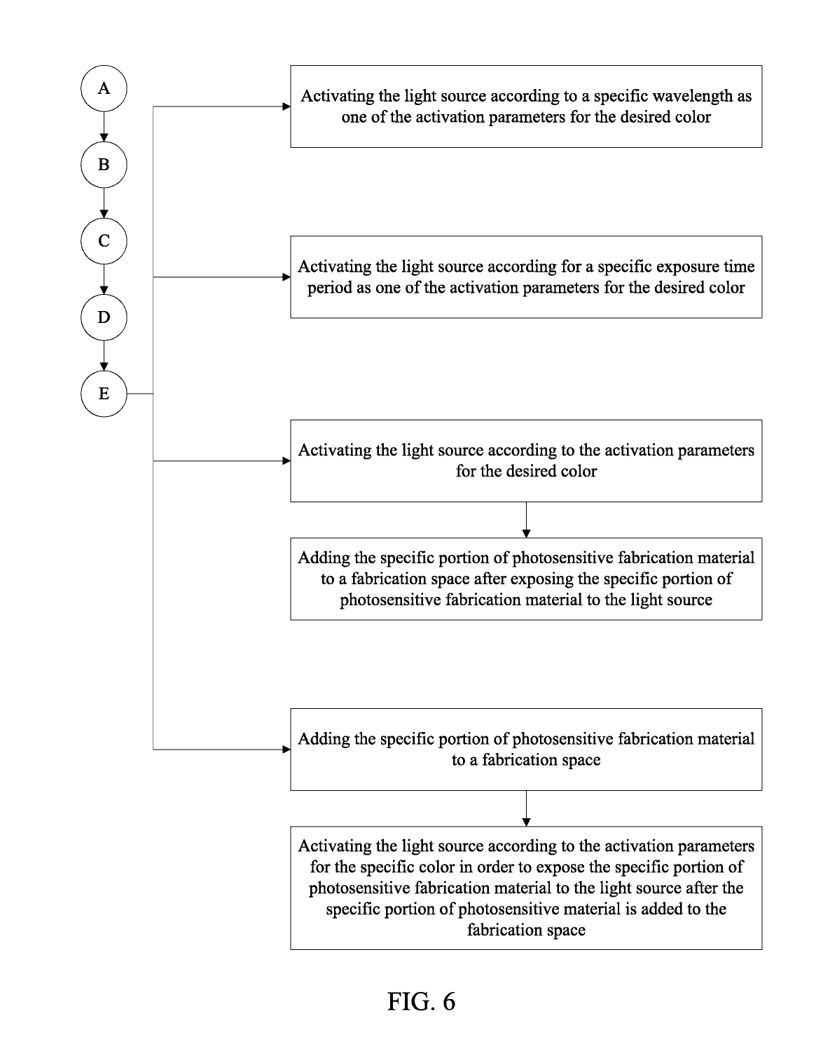

Referring to FIG. 6, in one embodiment, the only activation parameter necessary for the light source to change the color of the photosensitive fabrication material is wavelength of the light emitted. Thus, in said embodiment, the light source is activated according to a specific wavelength as one of the activation parameters for the desired color, wherein exposing the specific portion of the photosensitive fabrication material to the light source at the specific wavelength results in the specific portion of photosensitive fabrication material changing color to the desired color.

In one embodiment, the only activation parameter necessary for the light source to change the color of the photosensitive fabrication material is exposure time to the light emitted. Thus, in said embodiment, the light source is activated according to a specific exposure time period as one of the activation parameters for the desired color, wherein exposing the specific portion of the photosensitive fabrication material to the light source for the specific time period results in the specific portion of photosensitive fabrication material changing color to the desired color.

In one embodiment, designating a wavelength and exposure time period are both required as activation parameters to achieve the desired color. Thus, in said embodiment, the light source is activated at a specific wavelength for a specific exposure time period as the activation parameters for the desired color, wherein exposing the specific portion of the photosensitive fabrication material to the light source at the specific wavelength for the specific time period results in the specific portion of photosensitive fabrication material changing color to the desired color.

In some embodiments, such as, but not limited to, embodiments utilizing fused deposition modeling (FDM), the light source is introduced into the system at different points. In the process. In FDM, a filament material is unwound from a coil and extruded through a nozzle in order to deposit material onto the print. In one embodiment, the light source exposes the photosensitive fabrication material to light before the photosensitive fabrication material is extruded from the nozzle into a fabrication space, wherein the fabrication space is the physical location in which the physical object is being 3D printed by the additive manufacturing unit. Thus, in said embodiment, the light source is activated according to the activation parameters for the desired color, and subsequently the specific portion of photosensitive fabrication material is added to the fabrication space after exposing the specific portion of photosensitive fabrication material to the light source.

In one embodiment, the specific portion of photosensitive fabrication material is added to the fabrication space, and subsequently the light source is activated according to the activation parameters for the desired color in order to expose the specific portion of photosensitive fabrication material to the light source after the specific portion of photosensitive fabrication material is added to the fabrication space.

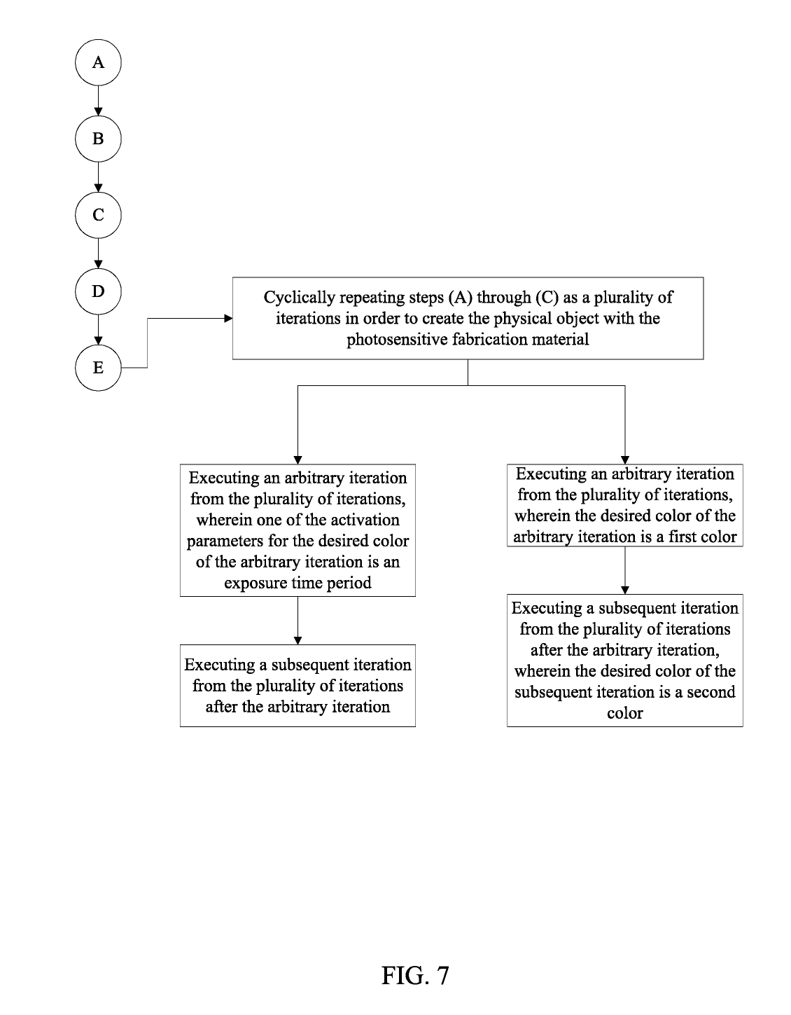

Referring to FIG. 7, the aforementioned general steps of the method of the present invention, (C) through (E), describe one iteration of the present invention, wherein in order to complete a 3D print of a physical object, many iterations of said process must be completed. Thus, steps (C) through (E) are repeated as a plurality of iterations in order to create the physical object with the photosensitive fabrication material. Any given iteration of steps (C) through (E) may a designated desired color independent of any other iteration. Thus, repeating steps (C) through (E) allows the physical object to be created regardless of the number of different portions of the digital 3D model which have different designated desired colors, allowing a multi-colored physical object to be created with the present invention.

In the case where one of the activation parameters for the desired color is an exposure time period, there must be a delay between iterations in order to allow the exposure time period to elapse. In general, in this case, an arbitrary iteration is executed from the plurality of iterations, wherein one of the activation parameters for the desired color of the arbitrary iteration is an exposure time period. One the exposure time period is elapsed, a subsequent iteration is executed from the plurality of iterations after the arbitrary iteration, wherein the subsequent iteration occurs directly after the arbitrary iteration in the plurality of iterations.

Similarly, in order to define differences between color in iterations, an arbitrary iteration and a subsequent iteration are again considered from the plurality of iterations. The desired color of the arbitrary iteration is a first color, and the desired color of the subsequent iteration is a second color. The arbitrary iteration is executed, and then the subsequent iteration is executed, creating a first portion of colored material, and subsequently a second portion of colored material, wherein the first portion and the second portion of colored material are differently colored after the arbitrary iteration and the subsequent iteration are executed.

The functionality of the present invention may be achieved through a variety of 3D printing processes, such as, but not limited to: fused deposition molding (FDM), light polymerization, and powder bed printing.

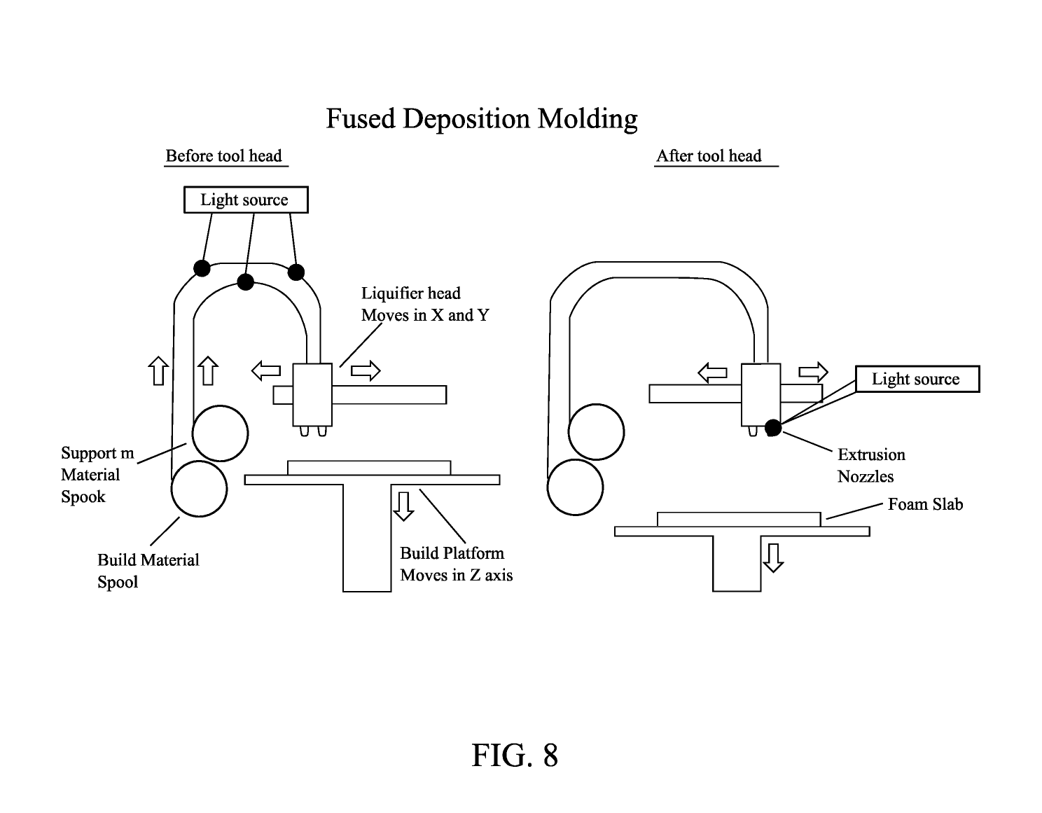

FDM is extrusion printing, generally using thermoplastic filaments as printing materials. Referring to FIG. 8, as previously discussed, in FDM, the light source may be located on the extruder mechanism itself, either before the filament enters the nozzle, and/or after the filament exits the nozzle. Alternatively, the light source may be separate from the extruder mechanism, coloring material before it enters the tool head or the 3D printer itself.

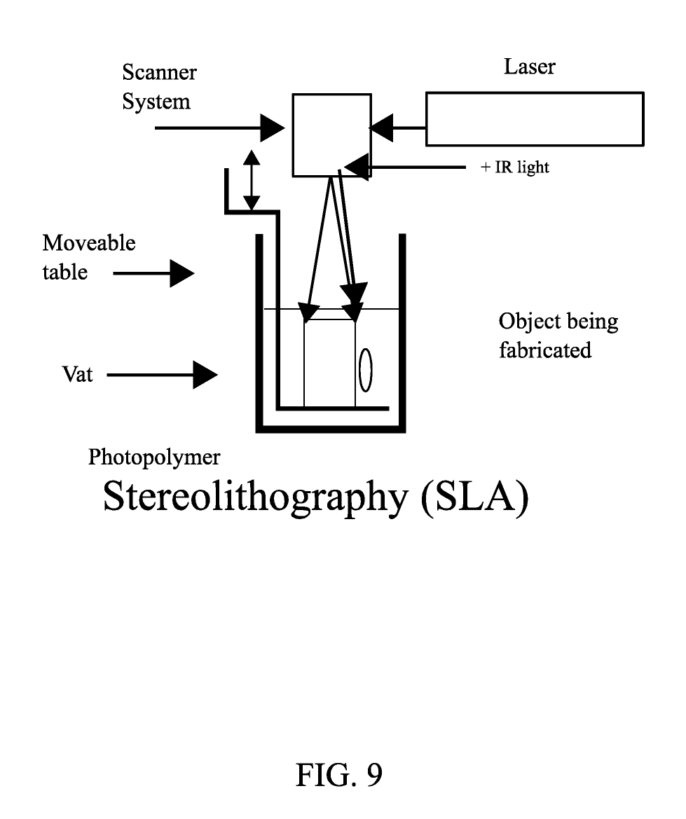

Referring to FIG. 9, light polymerization is resin printing via ultraviolet (UV) light, including stereolithography (SLA) and digital light processing (DLP) techniques. SLA is UV laser printing using galvo driven motors, using a vat of resin with either a projector or laser curing the resin in layers to form an object. Galvo directed lasers trace across the surface, solidifying the liquid resin between the surface and the model being printed. DLP is projected IR light, usually from a video projector. DLP is generally the same as SLA but uses non laser light sources like DLP projectors or LEDs. For SLA, the light source can either be IR lasers in the case of laser SLA driven by galvos, or projected IR in the case of DLP printers (direct projection or mirror reflected). IR emitters can be driven in-line with the printing emitter, or during pauses after the printing emitter finishes a layer or series of layers.

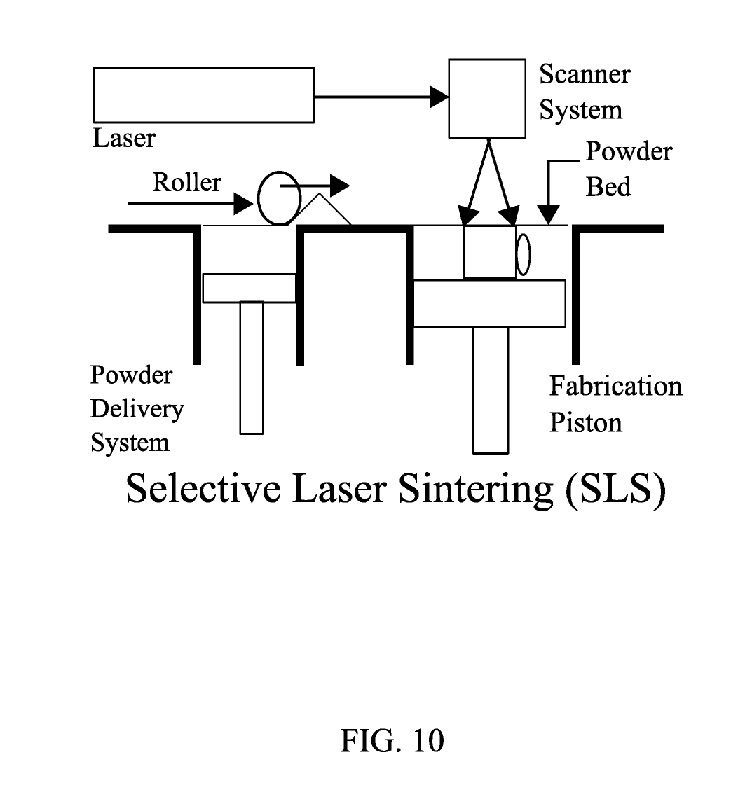

Referring to FIG. 10, powder bed printing applications considered herein are selective laser sintering (SLS) and inkjet powder printing. For SLS, the IR light source could be either integrated into the printing laser array, or a separate light source that will follow the printing laser to color the material. For inkjet powder printing, an IR reactive material could be applied via an inkjet head to the powder bed. Colorant activation by the light source would follow the binder inkjet head to color the material after it is hardened layer by layer, or by another tool head.

Another embodiment to consider could include a post print processing machine into which a printed object would be placed. Using either 3D scanning or other design or control tools, a full color surface could be activated on the print via a 360 degree of light emitters such as lasers, LED, DLP, or other emitters, or a moveable light source tool head.

The following is an alternate description of the present invention, and should be considered to be an exemplary description to supplementarily characterize the spirit of the present invention, and should not be considered to be limiting.

The present invention is a technique for producing 3D printed objects with one or more colors. The present invention adds infrared activated coloring material into selected 3D printing material. When exposed to different wavelengths, the infused material will react by changing color. The material may change color due to the specific wavelength of light that it is exposed to, the duration of exposure, or both. Before explaining at least one embodiment of the present invention in detail, it is to be understood that the invention is not limited in its application to the details of the components and arrangements as described or illustrated. The invention is capable of other embodiments and of being utilized and carried out in various ways. It is also to be understood that the phrasing and terminology employed herein are for the purpose of description and should not be regarded as limiting. As such, the present invention is primarily used during additive manufacturing, but the method may be applied to many other settings, situations, and scenarios.

In the preferred embodiment, the present invention comprises a technique for full color additive manufacturing in conjunction with almost any 3D printer device. It is to be appreciated that the 3D printer may comprise components and arrangements known and understood by those skilled in the art, that may include but not be limited to a stepping motor, mobile building platform, position-ally adjustable extruder, height adjustable nozzle, heating element, sensors, a computer controller, and more. The computer controller is the primary control device to configure and actuate commands on the 3D printer. The computer controller may be integrated into the 3D printer or be a separate device that wirelessly or non-wirelessly interfaces with the 3D printer.

In the preferred embodiment of the present invention, the technique or method for full color additive manufacturing begins with adding or infusing infrared activated coloring material into 3D printing filament or other printing materials known and appreciated by those skilled in the art. Such materials may include but are not limited to limited to plastics, polymers, metals, composites, etc. For the purpose of description, said 3D filament or other printing materials will herein be referred to as printing material.

In the preferred embodiment of the present invention, after the infusing the printing material with the infrared activated coloring material, a light source that produces infrared wavelengths will be selected. The light source may be almost any type of light producing device, including but not being limited to a laser(s), light emitting diode(s), flashlights, etc. The light source will be capable of producing different wavelengths and frequencies. During the building/printing process, the printing material will be exposed to the light source, to which the output wavelengths will change the chemical properties of the printing material, creating a pre-selected color change of said printing material. The computer controller may be utilized to configure output wavelength(s), exposure duration(s), and other requirements necessary for the output of 3D printing and associated material color change. Overall, color change may be induced from to a multitude of factors: First, a fixed wavelength will change the color of the printing due to the duration of exposure. With this, the printing material being exposed to a first wavelength for a period of time, T1, may produce a first color, but being exposed to the first wavelength for a period of time, T2, may produce a second color, and so forth. Next, the printing material being exposed to a second wavelength for a period of time, T3, may produce the aforementioned first color or any other possible color to which it is programmed. Lastly, the color output may be directly correlated to the wavelength, with the duration of exposure being a non-factor, past a certain time period, Tx. With this, the printing material being exposed to a first wavelength for a period of time greater than or equal to a period of time Tx will output a first color, the printing material being exposed to a second wavelength for a period of time greater than or equal to a period of time Tx will output a second color, and so forth. As such, wavelength(s), exposure duration(s), and other factors and requirements will be configured in order to set up the 3D printer for the printing/building process. Additionally, the configurations may be input manually during the setup process or they may be saved to a memory storage device that interacts with the computer controller.

In the preferred embodiment of the present invention, before setting up the 3D printer for the printing/building process, the following steps will generally occur. To begin with, a 3D computer-aided design (CAD) model will be created or chosen from a database of pre-created CAD models. If users wish to build their own CAD model, a CAD 3D modeling software must be chosen. Using the selected CAD software, users will create a CAD model of the part(s) they wish to build. The CAD model will then be converted to standard tessellation (STL) or a similar file format compatible with the 3D printer and then sent to the computer controller.

In the preferred embodiment of the present invention, with the CAD model loaded onto the computer controller, the 3D printer will be setup and configured with the infrared activated color changing filament material, selected light source, wavelength(s), exposure duration(s), and additional machine input requirements known and appreciated by those skilled in the art. At this point, the 3D printer may be actuated to build a physical model of the CAD model.

In the preferred embodiment of the present invention, the light source will apply required wavelengths to the printing material for required durations in order to produce colored part(s). In general, the extruder on most 3D printers feed a strand of the printing material through a nozzle, melting it just before the material exits, to which it will quickly cool down and harden. With this, the light source may be positioned and programmed to apply wavelengths to the printing material before it enters the extruder, directly as it exits the nozzle, after it re-hardens, or any combination of the three, which would include the use of additional light sources. With the build process complete, the printed model will be removed from a building platform and post processing may occur.

Although the invention has been explained in relation to its preferred embodiment, it is to be understood that many other possible modifications and variations can be made without departing from the spirit and scope of the invention as hereinafter claimed.

What is claimed is:

1. A method of additive manufacturing for producing three-dimensional objects with one or more colors through light exposure comprises the steps of:
(A) providing an additive manufacturing process, wherein the additive manufacturing process uses a photosensitive fabrication material to fabricate a physical object;
(B) providing a light source activation algorithm, wherein the light source activation algorithm correlates at least one activation parameter of a light source with one of a plurality of producible colors for the photosensitive printing material;
(C) designating a desired color for a specified portion of the photosensitive fabrication material, wherein the desired color is one of the producible colors;
(D) inputting the desired color and at least one photosensitive property of the photosensitive fabrication material into the light source activation algorithm in order to output at least one activation parameter for the desired color; and
(E) exposing the specified portion of the photosensitive fabrication material to the light source by activating the light source according to the at least one activation parameter for the desired color during the additive manufacturing process.

2. The method of additive manufacturing for producing three-dimensional objects with one or more colors through light exposure as claimed in claim 1 comprises the step of:
executing the additive manufacturing process with an additive manufacturing unit in order to create the physical object with the photosensitive fabrication material from a digital three dimensional (3D) model.

3. The method of additive manufacturing for producing three-dimensional objects with one or more colors through light exposure as claimed in claim 1 comprises the steps of:
providing a digital three dimensional (3D) model, wherein the digital 3D model is a virtual representation of the physical object; and
designating the desired color for a specified portion of the digital 3D model, wherein the specified portion of the photosensitive fabrication material corresponds to the specified portion of the digital 3D model.

4. The method of additive manufacturing for producing three-dimensional objects with one or more colors through light exposure as claimed in claim 1 comprises the step of:
creating the photosensitive fabrication material by adding photosensitive coloring material to standard additive fabrication material.

5. The method of additive manufacturing for producing three-dimensional objects with one or more colors through light exposure as claimed in claim 1 comprises the step of:
activating the light source according to a specific wavelength as one of the activation parameters for the desired color.

6. The method of additive manufacturing for producing three-dimensional objects with one or more colors through light exposure as claimed in claim 1 comprises the step of:
activating the light source according for a specific exposure time period as one of the activation parameters for the desired color.

7. The method of additive manufacturing for producing three-dimensional objects with one or more colors through light exposure as claimed in claim 1 comprises the steps of:
activating the light source according to the activation parameters for the desired color; and
adding the specific portion of photosensitive fabrication material to a fabrication space after exposing the specific portion of photosensitive fabrication material to the light source.

8. The method of additive manufacturing for producing three-dimensional objects with one or more colors through light exposure as claimed in claim 1 comprises the steps of:
adding the specific portion of photosensitive fabrication material to a fabrication space; and
activating the light source according to the activation parameters for the specific color in order to expose the specific portion of photosensitive fabrication material to the light source after the specific portion of photosensitive material is added to the fabrication space.

9. The method of additive manufacturing for producing three-dimensional objects with one or more colors through light exposure as claimed in claim 1 comprises the step of:
cyclically repeating steps (C) through (E) as a plurality of iterations in order to create the physical object with the photosensitive fabrication material.

10. The method of additive manufacturing for producing three-dimensional objects with one or more colors through light exposure as claimed in claim 9 comprises the steps of:
executing an arbitrary iteration from the plurality of iterations, wherein one of the activation parameters for the desired color of the arbitrary iteration is an exposure time period; and
executing a subsequent iteration from the plurality of iterations after the arbitrary iteration.

11. The method of additive manufacturing for producing three-dimensional objects with one or more colors through light exposure as claimed in claim 9 comprises the steps of:
executing an arbitrary iteration from the plurality of iterations, wherein the desired color of the arbitrary iteration is a first color; and
executing a subsequent iteration from the plurality of iterations after the arbitrary iteration, wherein the desired color of the subsequent iteration is a second color.
